(19) United States
(12) Patent Application Publication
(10) Pub. No.: US 2003/0178418 A1
(43) Pub. Date: Sep. 25, 2003

(54) Microwave device

(76) Inventors: Bernhard Herold, Regensburg (DE); Katrin Horn, Traunreut (DE); Kurt Lintner, Nussdorf (DE); Martin Schulte, Hagen (DE); Martin Thaler, Oberteisendorf (DE)

Correspondence Address: LERNER AND GREENBERG, P.A., POST OFFICE BOX 2480, HOLLYWOOD, FL, 33022-2480, US

(21) Appl. No.: 10/403,913

(22) Filed: Mar. 31, 2003

Related U.S. Application Data
(63) Continuation of application No. PCT/EP01/10958, filed on Sep. 21, 2001.

(30) Foreign Application Priority Data
Sep. 29, 2000 (DE) 100 48 444.1

(51) Int. Cl. H05B 6/64

(52) U.S. Cl. 219/685; 219/715

(57) ABSTRACT

A microwave device includes a cooking space disposed in a housing, at least one microwave source, and at least one further radiation source, as an alternative to the microwave source, which may be protected from microwaves by a protective device. The protective device has a control unit by which it is possible to establish a protective state for the alternative radiation source.

### CROSS-REFERENCE TO RELATED APPLICATION

This application is a continuation of copending International Application No. PCT/EP01/10958, filed Sep. 21, 2001, which designated the United States and was not published in English.

### BACKGROUND OF THE INVENTION

Field of the Invention

The present invention relates to a microwave device having a cooking space disposed in a housing, at least one microwave source, and at least one further radiation source as an alternative to the microwave source.

European Patent Application 1 005 255 A1, corresponding to U.S. Pat. No. 6,153,867 to Lee, discloses a generically determinative microwave device. The microwave device has a cooking space disposed in a housing, a microwave source, and a halogen lamp. The halogen lamp may be used as a heating element. To protect the halogen lamp, in particular, an incandescent filament of the halogen lamp, from microwaves from the microwave source, and to keep a leakage rate over power supply lines to the halogen lamp below defined limit values, a grating made of an electrically conductive material is disposed in front of the halogen lamp. A sheet metal plate provided with cutouts forms the grating.

### SUMMARY OF THE INVENTION

It is accordingly an object of the invention to provide a microwave device that overcomes the hereinafore-mentioned disadvantages of the heretofore-known devices of this general type and that increases efficiency in a microwave device.

With the foregoing and other objects in view, there is provided, in accordance with the invention, a microwave device, including a housing defining a cooking space therein, at least one microwave source supplying microwaves to the cooking space, at least one alternative radiation source supplying rays to the cooking space as an alternative to the at least one microwave source, and a protective device protecting the at least one alternative radiation source from the microwaves, the protective device having a control unit establishing a protective state for at least one alternative radiation source.

In accordance with another feature of the invention, the protective device has a control unit by which it is possible to establish a protective state for the alternative radiation source. By using the control unit, it is possible to implement a protective state for the alternative radiation source in a space-saving manner using few additional components and, overall, to achieve a good efficiency, specifically by being able to use a shielding unit to avoid absorption of rays from the radiation source during a prevailing operation using the alternative radiation source.

In accordance with a further feature of the invention, the control unit ensures that the alternative radiation source is switched off during operation of the microwave source and the microwave source is switched off during operation of the alternative radiation source. As a result, temporally offset operation is always ensured. If the control unit is, advantageously, integral with an already existing control unit, it is possible, advantageously, for the alternative radiation source to be protected without any additional components and associated structural space, installation effort, or cost. However, instead of one of the two sources being switched off completely, it is also conceivable, in principle, during prevailing operation using one source, for the control unit to set the other source to a very low power level.

In accordance with an added feature of the invention, the control unit has a microprocessor programmed to switch the at least one alternative radiation source off during operation of the at least one microwave source and to switch the at least one microwave source off during operation of the at least one alternative radiation source.

To be able to make use of the advantages of both sources during a cooking procedure, in a combined operation of the microwave source and the alternative radiation source, in accordance with an additional feature of the invention, the control unit operates the sources in alternating fashion. If, in this mode of operation, the individual operating times of the alternative radiation source and/or the microwave source can be set in dependence on an item to be cooked in the cooking space, the cooking process may be adapted to the particular item to be cooked, and a particularly advantageous cooking result may be achieved.

In accordance with yet another feature of the invention, it is also possible for the control unit to move a shielding unit, for example, a grating, in front of the alternative radiation source by a drive unit, and/or it is possible for the control unit to move the radiation source into a protected position by a drive unit and/or the drive unit moves the shielding unit to a position between the alternative radiation source and the microwave source. As such, a particularly reliable protection of the alternative radiation source is achieved. By moving the alternative radiation source into a protected position, it is possible for reliable protection to be achieved without any additional shielding unit.

Temporally offset operation and the measures of moving a shielding unit in front of the alternative radiation source and of moving the alternative radiation source into a protected position may be introduced by the control device individually or in various combinations.

The solution according to the invention may be implemented using various alternative radiation sources as deemed appropriate by the person skilled in the art, for example, sources that emit pure thermal radiation, etc. However, the solution according to the invention is implemented particularly advantageously when using radiation sources formed from light sources and having a filament. Light sources having a filament should, in particular, be protected or shielded from microwaves, specifically, at least to a large extent, to avoid damage to the filament and leakage of microwaves over the filament and its supply lines. The light source may emit predominantly visible light to illuminate the cooking space or may, advantageously, be configured such that it may be used as a heating element by it emitting, in particular, light in the infrared range, as is the case, for example, with halogen lamps. By using the solution according to the invention, it is possible for the light source to attain an advantageous heating efficiency.

In accordance with yet a further feature of the invention, the drive unit moves the at least one alternative radiation source while the at least one alternative radiation source operates.

In accordance with yet an added feature of the invention, the radiation source is driven such that it moves while operating. It is possible, in an advantageous manner, to make use of an already existing drive unit, either to move a shielding unit and/or, in particular, to move the radiation source into its protected position. However, it is also conceivable, in principle, to apply the solution according to the invention in the case of an alternative radiation source that is stationary during operation and is moved into a protected position prior to the operation of the microwave source by using an additional drive, for example.

With the objects of the invention in view, there is also provided a microwave device, including a housing defining a cooking space therein, at least one microwave source supplying microwaves to the cooking space, at least one alternative radiation source supplying rays to the cooking space as an alternative to the at least one microwave source, a protective device protecting the at least one alternative radiation source from the microwaves, the protective device having a control unit establishing a protective state for at least one alternative radiation source, the control unit switching the at least one alternative radiation source off during operation of the at least one microwave source and switching the at least one microwave source off during operation of the at least one alternative radiation source, a shielding unit, and a drive unit connected to the shielding unit and to the control unit, the control unit controlling movement of the shielding unit with the drive unit, the drive unit moving the shielding unit to a position protecting the at least one alternative radiation source from the microwaves of the at least one microwave source during operation of the at least one microwave source.

With the objects of the invention in view, there is also provided a microwave device, including a housing defining a cooking space therein, at least one microwave source supplying microwaves to the cooking space, at least one alternative radiation source supplying rays to the cooking space as an alternative to the at least one microwave source, a protective device protecting the at least one alternative radiation source from the microwaves, the protective device having a control unit establishing a protective state for at least one alternative radiation source, the control unit switching the at least one alternative radiation source off during operation of the at least one microwave source and switching the at least one microwave source off during operation of the at least one alternative radiation source, a drive unit connected to the control unit and to the at least one alternative radiation source, the drive unit moving the at least one alternative radiation source while the at least one alternative radiation source operates, and the control unit controlling movement of the at least one alternative radiation source into a protected position with the drive unit during operation of the at least one microwave source.

With the objects of the invention in view, there is also provided a microwave device, including a housing defining a cooking space therein, at least one microwave source supplying microwaves to the cooking space, at least one further radiation source supplying rays to the cooking space, and a protective device protecting the at least one further radiation source from the microwaves, the protective device having a control unit establishing a protective state for at least one further radiation source.

Other features that are considered as characteristic for the invention are set forth in the appended claims.

Although the invention is illustrated and described herein as embodied in a microwave device, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

The FIGURE is a fragmentary, cross-sectional view of a microwave device according to the invention.

### DESCRIPTION OF THE PREFERRED EMBODIMENTS

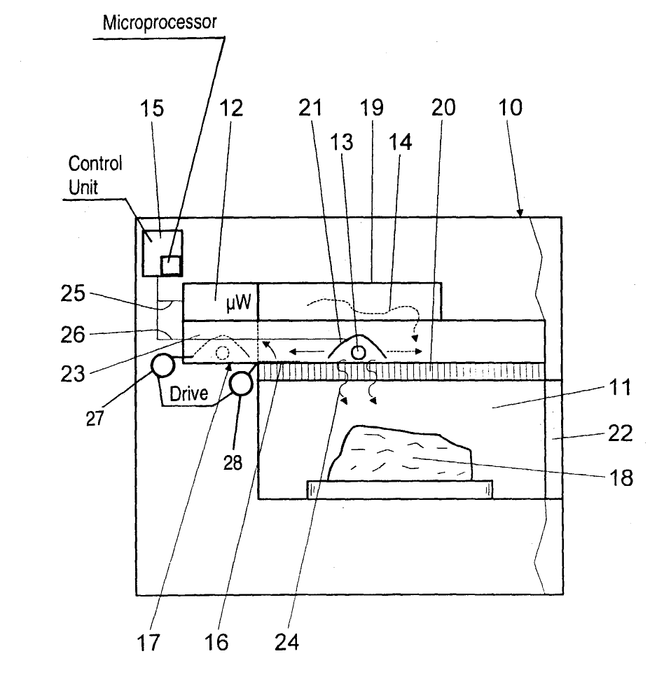

Referring now to the figures of the drawings in detail and first, particularly to FIG. 1 thereof, there is shown a diagrammatic representation, in longitudinal section, of a microwave device having a cooking space 11, disposed in a housing 10 that is closed by a door 22. The microwave device also has a microwave source 12 that is formed by a magnetron or a velocity-modulated tube and from which microwaves 14 can be conducted through a waveguide 19 into the cooking space 11 to heat an item to be cooked 18. In addition to the microwave source 12, the microwave device has a radiation source 13, as an alternative to the microwave source 12, which is formed by a halogen lamp. The radiation source 13 is disposed above a glass plate 20, forming the ceiling of the cooking space 11, and extends transversely over the entire width of the cooking space 11. The halogen lamp that forms the radiation source 13 has an incandescent filament by which it is possible to generate visible light to illuminate the cooking space 11 and invisible light in the infrared range to heat the item to be cooked 18. To deflect light radiating in the direction averted from the cooking space 11 into the cooking space 11, a shell-shaped reflector 21 surrounds the halogen lamp on the side remote from the cooking space 11. When the microwave device is operating using the halogen lamp, the lamp is moved back and forth above the cooking space 11 by a drive unit 27.

It is possible to protect the radiation source 13 from microwaves 14 by a protective device that, according to the invention, has a control unit 15 which is connected to the microwave source 12 and the alternative radiation source 13 by control lines 25, 26 and by which it is possible to establish a protective state for the radiation source 13. The control unit 15 can have a microprocessor programmed to control at least the microwave source 12 and the alternative radiation source 13. Prior to operation of the microwave source 12, the control unit 15 moves the radiation source 13 into a protected position 17, by its drive unit, into a space 23 adjacent to the cooking space 11 and switches it off. While moving to the protected position 17 in the space 23, the radiation source 13 travels over a grating that forms a shielding unit 16 and that, at that time, is still aligned parallel to the glass plate 20 and is pivotally mounted. As the radiation source 13 travels over the grating, a driving unit 28 that is fixed to the radiation source 13 latches into the grating. As the radiation source 13 continues to move, the grating 16 is pivoted into a perpendicular position so that the grating 16 closes the space 23 and shields the radiation source 13 from microwaves 14.

Prior to operation of the microwave device using the radiation source 13, the microwave source 12 is switched off by the control unit 15. The radiation source 13 is, then, moved from its position 17 in the space 23 above the cooking space 11 and, thereby, pivots the grating into a position aligned parallel to the glass plate 20. The radiation source 13 can, then, radiate into the cooking space 11 unimpeded. Light fluctuations and losses due to absorption of rays 24 from the radiation source 13 are avoided and a high efficiency is achieved. The control unit 15 operates the microwave source 12 and the radiation source 13 in a temporally offset manner.

In a combined operation using the microwave source 12 and the alternative radiation source 13, the microwave source 12 and the radiation source 13 are operated in alternating fashion by the control unit 15. In this mode of operation, it is possible for an operator, using an operating unit (not shown in any more detail) and by the control unit 15, to set the individual operating times of the radiation source 13 and the microwave source 12 dependent upon an item to be cooked in the cooking space 11.

We claim:

1. A microwave device, comprising:
a housing defining a cooking space therein;
at least one microwave source supplying microwaves to said cooking space;
at least one alternative radiation source supplying rays to said cooking space as an alternative to said at least one microwave source; and
a protective device protecting said at least one alternative radiation source from the microwaves, said protective device having a control unit establishing a protective state for at least one alternative radiation source.

2. The microwave device according to claim 1, wherein said control unit switches said at least one alternative radiation source off during operation of said at least one microwave source and switches said at least one microwave source off during operation of said at least one alternative radiation source.

3. The microwave device according to claim 1, wherein said control unit has a microprocessor programmed to switch said at least one alternative radiation source off during operation of said at least one microwave source and to switch said at least one microwave source off during operation of said at least one alternative radiation source.

4. The microwave device according to claim 2, wherein said control unit, in a combined operation using both said at least one microwave source and said at least one alternative radiation source, operates said at least one microwave source and said at least one alternative radiation source in alternating fashion.

5. The microwave device according to claim 4, wherein, in said combined operation, said control unit controls individual operating times of at least one of said at least one alternative radiation source and said at least one microwave source dependent upon an item to be cooked in said cooking space.

6. The microwave device according to claim 1, including a shielding unit and a drive unit connected to said shielding unit and to said control unit, said control unit controlling movement of said shielding unit with said drive unit.

7. The microwave device according to claim 6, wherein said drive unit moves said shielding unit to a position between said at least one alternative radiation source and said at least one microwave source.

8. The microwave device according to claim 6, wherein said drive unit moves said shielding unit to a position protecting said at least one alternative radiation source from the microwaves of said at least one microwave source.

9. The microwave device according to claim 1, including a drive unit connected to said control unit and to said at least one alternative radiation source, said control unit controlling movement of said at least one alternative radiation source into a protected position with said drive unit.

10. The microwave device according to claim 1, wherein said at least one alternative radiation source is a light source having a filament.

11. The microwave device according to claim 10, wherein said light source is a heating element.

12. The microwave device according to claim 9, wherein said drive unit moves said at least one alternative radiation source while said at least one alternative radiation source operates.

13. The microwave device according to claim 1, wherein said at least one alternative radiation source moves while operating.

14. A microwave device, comprising:
a housing defining a cooking space therein;
at least one microwave source supplying microwaves to said cooking space;
at least one alternative radiation source supplying rays to said cooking space as an alternative to said at least one microwave source;
a protective device protecting said at least one alternative radiation source from the microwaves, said protective device having a control unit establishing a protective state for at least one alternative radiation source, said control unit switching said at least one alternative radiation source off during operation of said at least one microwave source and switching said at least one microwave source off during operation of said at least one alternative radiation source;
a shielding unit; and
a drive unit connected to said shielding unit and to said control unit, said control unit controlling movement of said shielding unit with said drive unit, said drive unit moving said shielding unit to a position protecting said at least one alternative radiation source from the microwaves of said at least one microwave source during operation of said at least one microwave source.

15. A microwave device, comprising:
a housing defining a cooking space therein;
at least one microwave source supplying microwaves to said cooking space;
at least one alternative radiation source supplying rays to said cooking space as an alternative to said at least one microwave source;
a protective device protecting said at least one alternative radiation source from the microwaves, said protective device having a control unit establishing a protective state for at least one alternative radiation source, said control unit switching said at least one alternative radiation source off during operation of said at least one microwave source and switching said at least one microwave source off during operation of said at least one alternative radiation source;
a drive unit connected to said control unit and to said at least one alternative radiation source, said drive unit moving said at least one alternative radiation source while said at least one alternative radiation source operates; and
said control unit controlling movement of said at least one alternative radiation source into a protected position with said drive unit during operation of said at least one microwave source.

16. A microwave device, comprising:
a housing defining a cooking space therein;
at least one microwave source supplying microwaves to said cooking space;
at least one further radiation source supplying rays to said cooking space; and
a protective device protecting said at least one further radiation source from the microwaves, said protective device having a control unit establishing a protective state for at least one further radiation source.
